(19) United States
(12) Patent Application Publication
(10) Pub. No.: US 2021/0405632 A1
(43) Pub. Date: Dec. 30, 2021

(54) TECHNOLOGY TO CLUSTER MULTIPLE SENSORS TOWARDS A SELF-MODERATING AND SELF-HEALING PERFORMANCE FOR AUTONOMOUS SYSTEMS

(71) Applicant: Intel Corporation, Santa Clara, CA (US)

(72) Inventors: Rita Wouhaybi, Portland, OR (US); Sangeeta Manepalli, Chandler, AZ (US); Siew Wen Chin, Penang (MY); Hassnaa Moustafa, Sunnyvale, CA (US)

(21) Appl. No.: 17/469,976

(22) Filed: Sep. 9, 2021

(51) Int. Cl. G05B 23/02

(52) U.S. Cl. CPC G05B 23/0283

(57) ABSTRACT

Systems, apparatuses and methods may provide for technology that groups sensor data into a plurality of clusters based on feature similarity, conducts an artificial intelligence (AI) analysis of the plurality of clusters, and detects a data defect based on the AI analysis.

### TECHNICAL FIELD

This disclosure relates generally to sensor management. More particularly, embodiments relate to technology that clusters multiple sensors towards a learning-based defect detection, self-moderating and self-healing performance for autonomous systems.

### BACKGROUND OF THE DISCLOSURE

Sensors are used to collect data in a wide variety of autonomous systems such as vehicles, industrial systems, Internet of Things (TOT) systems, and so forth. When a sensor-based algorithm for autonomous systems is created, the underlying assumption is typically that the training data is trustworthy, consistent, and uniform across similar sensors. The reality, however, is that the data used for training might be collected using an infrastructure that is different from the deployment scenario (e.g., different types of sensors provide the training data, synthetic data is used in training, the environment for data collection for training is different, etc.). In addition, sensors may experience data drift over time and frequent usage after deployment. Conventional solutions may monitor sensor health either through physical indicators such as LEDs (light emitting diodes) or through error calibration algorithm(s) (e.g., used towards the end of the sensor lifetime). In many instances, the autonomous system may be taken offline while the sensor is physically replaced. Additionally, an unchecked sensor might operate for a considerable amount of time before the sensor is discovered to be drifting. As a result, current solutions may rely on inaccurate data that can have a negative impact the quality of autonomous decisions.

### BRIEF DESCRIPTION OF THE DRAWINGS

So that the manner in which the features of the present embodiments can be understood in detail, a more particular description of the embodiments may be had by reference to embodiments in the following detailed description, some of which are illustrated in the appended drawings. It is to be noted, however, that the appended drawings illustrate only typical embodiments and are therefore not to be considered limiting of the scope of the embodiments.

FIG. 1 is an illustration of an example of a sensor management solution according to an embodiment;

FIG. 2 is a block diagram of an example of a sensor data clustering solution according to an embodiment;

FIG. 3 is a flowchart of an example of a method of conducting continuous data verification according to an embodiment;

FIG. 4 is a flowchart of an example of a method of operating a performance-enhanced autonomous system according to an embodiment;

FIG. 5 is a block diagram of an example of a performance-enhanced autonomous system according to an embodiment;

FIG. 6 is an illustration of an example of a semiconductor package apparatus according to an embodiment;

FIG. 7 is a block diagram of an example of a processor according to an embodiment; and

FIG. 8 is a block diagram of an example of a multi-processor based computing system according to an embodiment.

### DETAILED DESCRIPTION

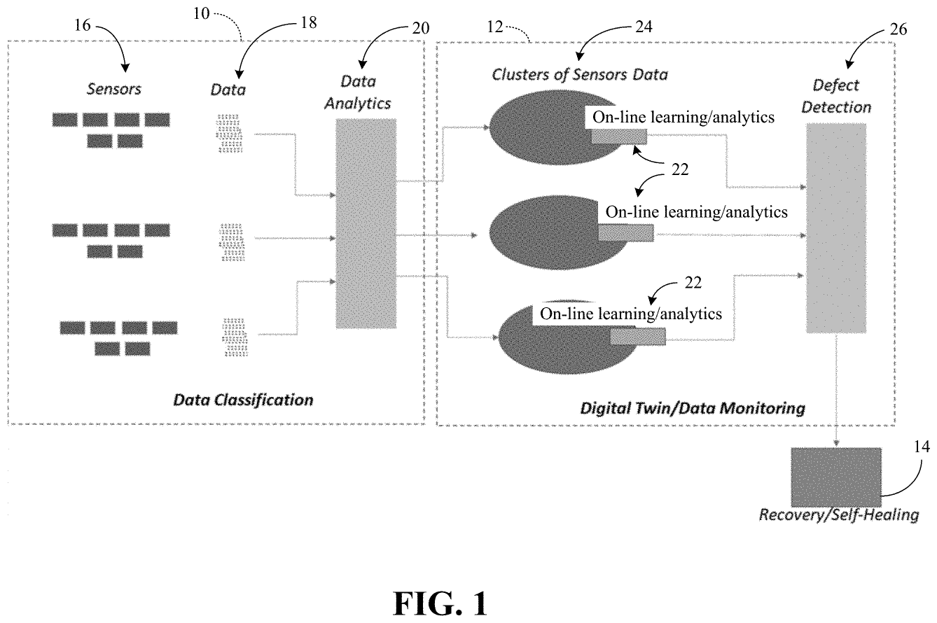

FIG. 1 shows a sensor management solution that includes a data classification phase 10, a data monitoring phase 12 (e.g., digital twin), and a self-healing phase 14 (e.g., recovery). The solution may be used in an autonomous system such as, for example, a drone, robot, vehicle, industrial system, IOT system, and so forth. In the illustrated data classification phase 10, a plurality of sensors 16 generate data 18 and continuous data analytics 20 take place to identify related patterns between the data 18 generated by the sensors 16. Data analytics 20 classify the sensors 16 based on the type of data 18 generated by the sensors 16 over time. The data 18 is grouped into a plurality of clusters 24, where the data monitoring phase 12 conducts continuous learning and analytics 22 within each created cluster 24 to detect any divergence/unexpected pattern upon the arrival of new data. When a data defect is detected by a defect detection subsystem 26, the self-healing phase 14 is triggered (e.g., to provide a self-moderating solution).

From a deployment perspective, the data classification phase 10 can be co-located with each sensor 16 or positioned between the sensors 16 and an edge platform (not shown) connected to the sensors 16. Additionally, the data monitoring phase 12 can reside in an edge platform connected to the sensors 16 or in a cloud computing infrastructure (“cloud”, not shown).

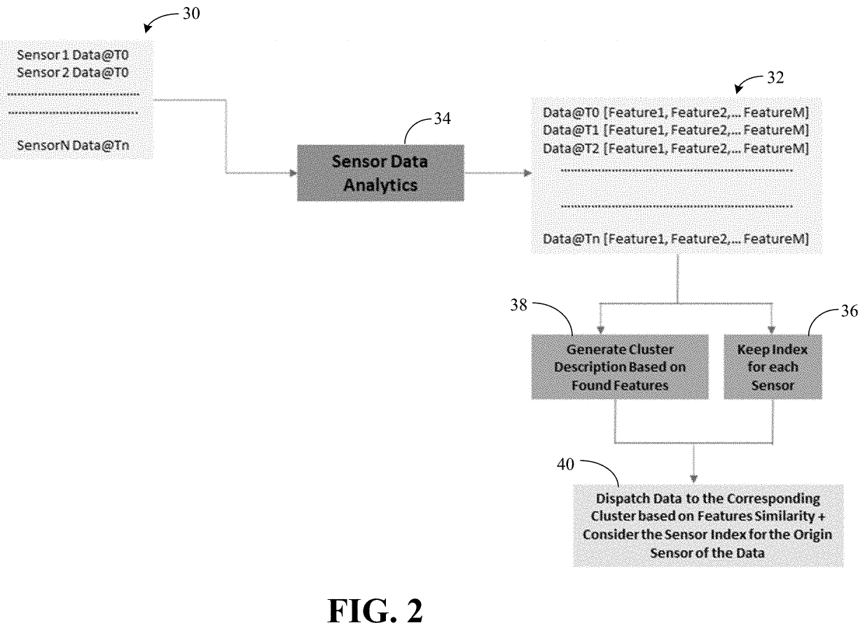

FIG. 2 demonstrates that at the beginning of deployment or when an autonomous system is enabled, data streams 30 (e.g., from sensors or controllers) may be observed and used to compute statistical measures 32 of the data. As more data flows, these measures 32 are then used to group the streams 30 into clusters based on similarities of the statistical measures 32. For example, a set of temperature, humidity and air quality sensor streams might have more commonalities amongst themselves than with other sensors such as a torque sensor stream from a screwdriver process. This clustering functions as a digital equivalent for the sensor, helping predictive maintenance and ensuring defect detection in the data coming from the sensors during the lifetime of the sensors.

More particularly, data analytics 34 take place for the data streams 30 through multi-class classification to identify multiple features that can help map the data to a specific cluster. The multi-class classification can reflect several features such as, for example, the location of data collection, time of the data collection, environment (e.g., indoor versus outdoor), sensor type, sensor data health and characteristics. Following the classification process, the data from sensors is clustered according to the class (and hence features) similarity. In an embodiment, a process block 36 tracks indices of sensors associated with the sensor data. Additionally, a process block 38 may assign labels (e.g., cluster description metadata reflecting the scope of features in each cluster) to the plurality of clusters. Process block 40 dispatches the data to the corresponding clusters based on feature similarity, while considering the sensor index for the originating sensor of the data.

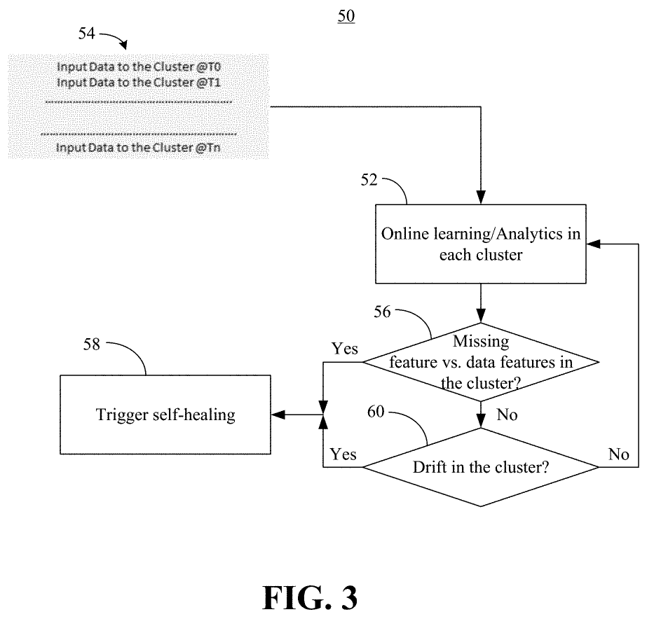

FIG. 3 shows a method 50 of conducting continuous data verification. The method 50 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable hardware such as, for example, programmable logic arrays (PLAs), field programmable gate arrays (FPGAs), complex programmable logic devices (CPLDs), in fixed-functionality hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 50 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

In general, during the lifetime of the sensors and the system, continuous verification of the data takes place within each cluster for every batch of new data during a telemetry process. Illustrated processing block 52 applies machine learning (ML) or other artificial intelligence (AI) analysis on data samples 54 in each cluster to determine the data trend similarity or data divergence. This continuous learning of the data trend in each cluster provides a a digital equivalent for each sensor. The digital equivalent enables verification on the quality/correctness of data from each sensor (and hence the health of the sensor) and triggers a recovery mechanism upon defect detection for the data from any sensor. The ML considers multi-class classification (e.g., where the number of classes equals the number of features for data from each sensor) and detects the level of feature coverage for the data collected from each sensor. In the illustrated example, block 56 determines whether there are missing features in the cluster. If so, block 58 triggers a self-healing procedure. Otherwise, block 60 determines whether there is observed drift in the cluster. If so, block 58 triggers the self-healing procedure. Otherwise, the method 50 returns to block 52.

Once a data defect is detected, recovery mechanisms take place to substitute for the missing data and/or defected data coming from sensors. The following are diverse approaches for recovery and self-healing.

Data generation: Substituting the defected/missing data from a sensor/group of sensors, through heuristics and historical data from the same sensor(s).

Data prediction: Substituting the defected/missing data from a sensor/group of sensors, making use of the observed pattern of data in each cluster over time.

Reduction of data points: Omitting and/or removing the role of the sensor/group of sensors identified to have defective data and working with the remaining sensors.

Relative adjustment: In certain cases, it may be more appropriate not to replace the data stream completely but rather shift the data stream (e.g., accounting for the drift instead of complete replacement to keep certain characteristics that the sensor has, which might be important for the application).

If the sensor/group of sensors identified to produce defective data continues generating defective data, then physical intervention (e.g., repair, replacement) of the sensor(s) may be performed.

As AI solutions are developed for autonomous environments such as factories, embodiments will create a cluster of the dataset used as metadata to the AI solution. This metadata is then used to understand whether data has changed considerably from training to deployment (e.g., inference). If the data has drifted, then the drift can be measured based on how the clusters of the sensor data have changed or some sensors have migrated out of a cluster and into another. This change can then be evaluated to highlight what kind of tuning is appropriate for the AI analysis. The clusters can be mapped to different parts and/or layers of a deep learning (DL) network, if possible. In other cases, the extent of the quantified drift can then be used if needed to identify when to tune the AI analysis.

Embodiments rely on the fact that drift can be attributed to issues with the sensor versus the process changing. Therefore, additional information may be incorporated into the sensor/stream. The system may include a trigger function that will detect a drift due to potential sensor issue. This trigger is a self-learning component that relies on the context of the environment, which may include the following items: what other sensors are experiencing potential drift, sensor type, software updates to the sensor or devices that manage the sensor (e.g., a controller that reads the sensor), physical location and placement of the sensor monitoring for any recent change, the addition or removal of other equipment in the vicinity, and so forth. Based on these parameters, some changes would be expected (e.g., the sensor is not drifting due to dysfunction). If the changes are substantial, then re-training may be conducted.

An additional use case to embodiments is in unsupervised learning where AI models/solutions readjust automatically. In such a case, embodiments trigger auto-tuning of parameters or initiate reinforcement learning (e.g., returning to a training phase).

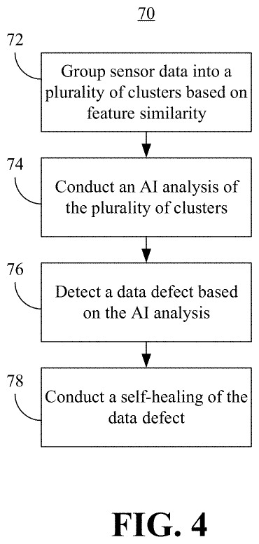

FIG. 4 shows a method 70 of operating a performance-enhanced autonomous system. The method 70 may be implemented as one or more modules in a set of logic instructions stored in a non-transitory machine- or computer-readable storage medium such as RAM, ROM, PROM, firmware, flash memory, etc., in configurable hardware such as, for example, PLAs, FPGAs, CPLDs, in fixed-functionality hardware using circuit technology such as, for example, ASIC, CMOS or TTL technology, or any combination thereof.

Illustrated processing block 72 provides for grouping sensor data into a plurality of clusters based on feature similarity. For example, in an industrial application, sensors in the vicinity of a conveyor belt might include temperature sensors, humidity sensors, barometric pressure sensors, accelerometers, microphones, and so forth. In such a case, block 72 might automatically form an “air quality” cluster for the data streams obtained from the temperature, humidity and barometric pressure sensors and automatically form a “physical environment” cluster for the data streams obtained from the accelerometers and microphones. Thus, both the air quality cluster and the physical environment cluster may provide insight as to whether the conveyor belt is experiencing excessive vibration (e.g., air moisture measured by the air quality cluster and/or motion measured by the physical environment cluster). Block 72 may also assign labels to the plurality of clusters and track indices of sensors associated with the sensor data.

Block 74 conducts an AI analysis of the plurality of clusters. In an embodiment, block 74 uses machine learning and/or neural network technology to determine whether one or more features of the respective clusters are missing from the real-time data streams. Thus, block 74 might detect that barometric pressure data points are missing from the air quality cluster data or that audio data points are missing from the physical environment cluster (e.g., ambient noise is drowning out the sound of the conveyor belt). Block 74 may also detect that temperature drift is observed in the air quality cluster or that motion drift is observed in the physical environment cluster. Block 76 detects a data defect based on the AI analysis. Additionally, block 78 conducts a self-healing of the data defect.

For example, block 78 may substitute historical data for data associated with the data defect. Thus, in the example of barometric pressure data points missing from the air quality cluster data, block 78 may substitute historical data from the barometric pressure sensor taken during a similar time of day and/or year for the missing barometric pressure data points. Indeed, the substitute historical data may be taken from the same cluster or a different cluster, depending on the circumstances.

Block 78 may also predict a future defect based on the detected data defect. Thus, in the example of audio data points missing from the physical environment cluster, block 78 may determine that ambient noise typically occurs during certain time periods (e.g., beginning or end of employee shifts) and predict that the audio data points will be missing during future instances of those time periods.

In addition, block 78 may remove (e.g., omit) one or more data points associated with the data defect. Thus, if block 76 determines that the data from a humidity sensor is not trustworthy (e.g., subject to a malware attack), inconsistent and/or non-uniform with respect to other humidity sensors, block 78 might remove the defective humidity data from the data provided to the autonomous system.

Moreover, if the data defect is a drift condition, block 78 may modify a portion of the sensor data from a sensor associated with the data defect based on the drift condition. Thus, in the example, of temperature drift being observed in the air quality sensor cluster (e.g., due to end of life deterioration in the temperature sensor), block 78 may adjust the data from the temperature sensor to account for the temperature drift. The method 70 therefore enhances performance at least to the extent that cluster-based detection of data defects enables predictive maintenance for the data rather than solely relying on predictive maintenance for the sensors (e.g., data sources) themselves.

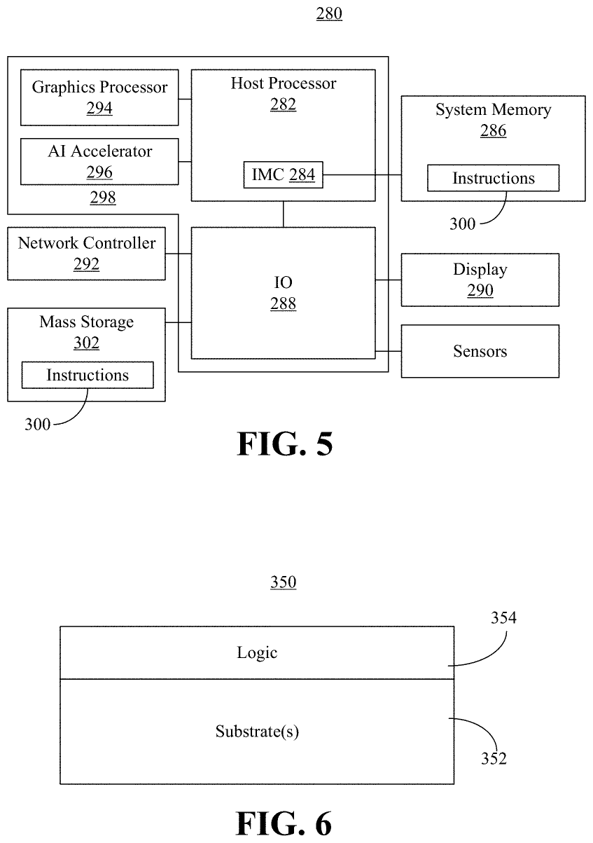

Turning now to FIG. 5, a performance-enhanced autonomous system 280 is shown. The system 280 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., CPU) having an integrated memory controller (IMC) 284 that is coupled to a system memory 286 (e.g., dual inline memory module/DIMM). In an embodiment, an IO (input/output) module 288 is coupled to the host processor 282. The illustrated IO module 288 communicates with, for example, a display 290 (e.g., touch screen, liquid crystal display/LCD, light emitting diode/LED display), a plurality of sensors 291, and a network controller 292 (e.g., wired and/or wireless). The host processor 282 may be combined with the IO module 288, a graphics processor 294, and an AI accelerator 296 into a system on chip (SoC) 298.

In an embodiment, the host processor 282 executes a set of program instructions 300 retrieved from mass storage 302 and/or the system memory 286 to perform one or more aspects of the method 50 (FIG. 3) and/or the method 70 (FIG. 4), already discussed. Thus, execution of the illustrated instructions 300 by the host processor 282 causes the host processor 282 to group sensor data into a plurality of clusters based on feature similarity, conduct an AI analysis of the plurality of clusters, and detect a data defect based on the AI analysis. The functionality of the instructions 300 may also be incorporated into the AI accelerator 296. The autonomous system 280 is therefore considered performance-enhanced at least to the extent that cluster-based detection of data defects enables predictive maintenance for the data rather than solely relying on predictive maintenance for the sensors 291 themselves.

FIG. 6 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 50 (FIG. 3) and/or the method 70 (FIG. 4), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

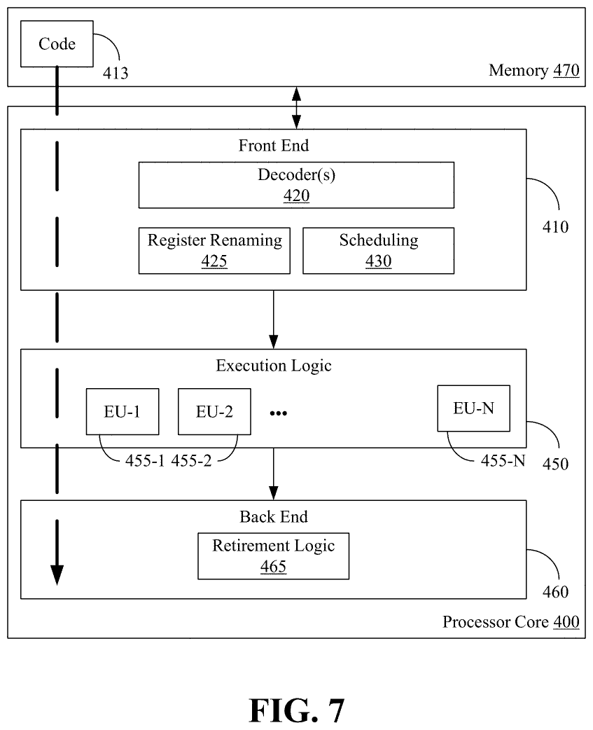

FIG. 7 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 7, a processing element may alternatively include more than one of the processor core 400 illustrated in FIG. 7. The processor core 400 may be a single-threaded core or, for at least one embodiment, the processor core 400 may be multithreaded in that it may include more than one hardware thread context (or “logical processor”) per core.

FIG. 7 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 50 (FIG. 3) and/or the method 70 (FIG. 4), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 7, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

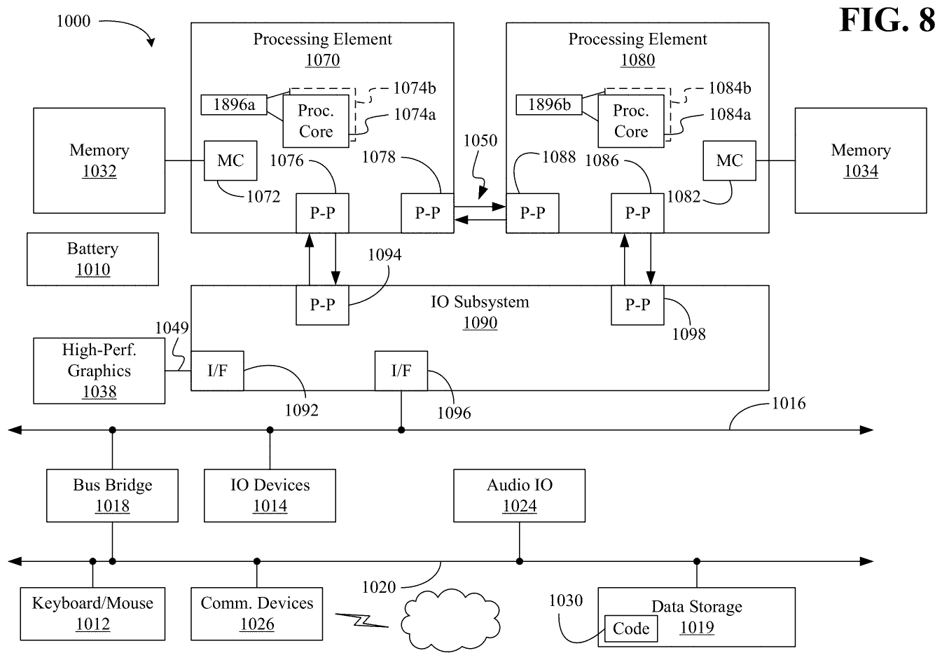

Referring now to FIG. 8, shown is a block diagram of a computing system 1000 embodiment in accordance with an embodiment. Shown in FIG. 8 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 8 may be implemented as a multi-drop bus rather than point-to-point interconnect.

As shown in FIG. 8, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 7.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 8, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 8, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 8, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 50 (FIG. 3) and/or the method 70 (FIG. 4), already discussed. Further, an audio I/O 1024 may be coupled to second bus 1020 and a battery 1010 may supply power to the computing system 1000.

Note that other embodiments are contemplated. For example, instead of the point-to-point architecture of FIG. 8, a system may implement a multi-drop bus or another such communication topology. Also, the elements of FIG. 8 may alternatively be partitioned using more or fewer integrated chips than shown in FIG. 8.

### Additional Notes and Examples

Example 1 includes a performance-enhanced autonomous system comprising a network controller, a processor coupled to the network controller, and a memory coupled to the processor, the memory including a set of instructions, which when executed by the processor, cause the processor to group sensor data into a plurality of clusters based on feature similarity, conduct an artificial intelligence (AI) analysis of the plurality of clusters, and detect a data defect based on the AI analysis.

Example 2 includes the autonomous system of Example 1, wherein the instructions, when executed, further cause the processor to substitute historical data for data associated with the data defect.

Example 3 includes the autonomous system of Example 1, wherein the instructions, when executed, further cause the processor to predict a future defect based on the detected data defect.

Example 4 includes the autonomous system of Example 1, wherein the instructions, when executed, further cause the processor to remove one or more data points associated with the data defect.

Example 5 includes the autonomous system of any one of Examples 1 to 4, wherein the data defect is a drift condition and the instructions, when executed, further cause the autonomous system to modify a portion of the sensor data from a sensor associated with the data defect based on the drift condition.

Example 6 includes at least one computer readable storage medium comprising a set of instructions, which when executed by an autonomous system, cause the autonomous system to group sensor data into a plurality of clusters based on feature similarity, conduct an artificial intelligence (AI) analysis of the plurality of clusters, and detect a data defect based on the AI analysis.

Example 7 includes the at least one computer readable storage medium of Example 6, wherein the instructions, when executed, further cause the autonomous system to substitute historical data for data associated with the data defect.

Example 8 includes the at least one computer readable storage medium of Example 6, wherein the instructions, when executed, further cause the autonomous system to predict a future defect based on the detected data defect.

Example 9 includes the at least one computer readable storage medium of Example 6, wherein the instructions, when executed, further cause the autonomous system to remove one or more data points associated with the data defect.

Example 10 includes the at least one computer readable storage medium of Example 6, wherein the data defect is a drift condition and the instructions, when executed, further cause the autonomous system to modify a portion of the sensor data from a sensor associated with the data defect based on the drift condition.

Example 11 includes the at least one computer readable storage medium of any one of Examples 6 to 10, wherein the instructions, when executed, further cause the autonomous system to assign labels to the plurality of clusters.

Example 12 includes the at least one computer readable storage medium of any one of Examples 6 to 10, wherein the instructions, when executed, further cause the autonomous system to track indices of sensors associated with the sensor data.

Example 13 includes a semiconductor apparatus comprising one or more substrates, and logic coupled to the one or more substrates, wherein the logic is implemented at least partly in one or more of configurable or fixed-functionality hardware, the logic to group sensor data into a plurality of clusters based on feature similarity, conduct an artificial intelligence (AI) analysis of the plurality of clusters, and detect a data defect based on the AI analysis.

Example 14 includes the semiconductor apparatus of Example 13, wherein the logic is to substitute historical data for data associated with the data defect.

Example 15 includes the semiconductor apparatus of Example 13, wherein the logic is to predict a future defect based on the detected data defect.

Example 16 includes the semiconductor apparatus of Example 13, wherein the logic is to remove one or more data points associated with the data defect.

Example 17 includes the semiconductor apparatus of Example 13, wherein the data defect is a drift condition and the logic is to modify a portion of the sensor data from a sensor associated with the data defect based on the drift condition.

Example 18 includes the semiconductor apparatus of any one of Examples 13 to 17, wherein the logic is to assign labels to the plurality of clusters.

Example 19 includes the semiconductor apparatus of any one of Examples 13 to 17, wherein the logic is to track indices of sensors associated with the sensor data.

Example 20 includes the semiconductor apparatus of any one of Examples 13 to 17, wherein the logic includes transistor channel regions that are positioned within the one or more substrates.

Example 21 includes a method of operating a performance-enhanced autonomous system, the method comprising grouping sensor data into a plurality of clusters based on feature similarity, conducting an artificial intelligence (AI) analysis of the plurality of clusters, and detecting a data defect based on the AI analysis.

Example 22 includes the method of Example 21, further including substituting historical data for data associated with the data defect.

Example 23 includes the method of Example 21, further including predicting a future defect based on the detected data defect.

Example 24 includes the method of Example 21, further including removing one or more data points associated with the data defect.

Example 25 includes the method of any one of Examples 21 to 24, wherein the data defect is a drift condition and the method further includes modifying a portion of the sensor data from a sensor associated with the data defect based on the drift condition.

Example 26 includes means for performing the method of any one of Examples 21 to 25.

Thus, technology described herein uses clustering mechanisms to understand similarities of data sources (e.g., sensors) and create a signature for each formed cluster (e.g., using descriptive metadata, trust/confidence level in the sensor data, and possible other metrics). As deployment occurs, the sensor data is monitored to determine any drift, impact on the AI solution and potential data stream replacement if needed. The technology provides predictive maintenance for the data rather than solely relying on predictive maintenance for the sensors themselves. Also, the clustering of sensors enables sensor input swapping and/or potentially simulating sensor data augmented with other sensors until a physical replacement is possible.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An autonomous system comprising:
a network controller;
a processor coupled to the network controller; and
a memory coupled to the processor, the memory including a set of instructions, which when executed by the processor, cause the processor to:
group sensor data into a plurality of clusters based on feature similarity,
conduct an artificial intelligence (AI) analysis of the plurality of clusters, and
detect a data defect based on the AI analysis.

2. The autonomous system of claim 1, wherein the instructions, when executed, further cause the processor to substitute historical data for data associated with the data defect.

3. The autonomous system of claim 1, wherein the instructions, when executed, further cause the processor to predict a future defect based on the detected data defect.

4. The autonomous system of claim 1, wherein the instructions, when executed, further cause the processor to remove one or more data points associated with the data defect.

5. The autonomous system of claim 1, wherein the data defect is a drift condition and the instructions, when executed, further cause the autonomous system to modify a portion of the sensor data from a sensor associated with the data defect based on the drift condition.

6. At least one computer readable storage medium comprising a set of instructions, which when executed by an autonomous system, cause the autonomous system to:
group sensor data into a plurality of clusters based on feature similarity;
conduct an artificial intelligence (AI) analysis of the plurality of clusters; and
detect a data defect based on the AI analysis.

7. The at least one computer readable storage medium of claim 6, wherein the instructions, when executed, further cause the autonomous system to substitute historical data for data associated with the data defect.

8. The at least one computer readable storage medium of claim 6, wherein the instructions, when executed, further cause the autonomous system to predict a future defect based on the detected data defect.

9. The at least one computer readable storage medium of claim 6, wherein the instructions, when executed, further cause the autonomous system to remove one or more data points associated with the data defect.

10. The at least one computer readable storage medium of claim 6, wherein the data defect is a drift condition and the instructions, when executed, further cause the autonomous system to modify a portion of the sensor data from a sensor associated with the data defect based on the drift condition.

11. The at least one computer readable storage medium of claim 6, wherein the instructions, when executed, further cause the autonomous system to assign labels to the plurality of clusters.

12. The at least one computer readable storage medium of claim 6, wherein the instructions, when executed, further cause the autonomous system to track indices of sensors associated with the sensor data.

13. A semiconductor apparatus comprising:
one or more substrates; and
logic coupled to the one or more substrates, wherein the logic is implemented at least partly in one or more of configurable or fixed-functionality hardware, the logic to:
group sensor data into a plurality of clusters based on feature similarity;
conduct an artificial intelligence (AI) analysis of the plurality of clusters; and
detect a data defect based on the AI analysis.

14. The semiconductor apparatus of claim 13, wherein the logic is to substitute historical data for data associated with the data defect.

15. The semiconductor apparatus of claim 13, wherein the logic is to predict a future defect based on the detected data defect.

16. The semiconductor apparatus of claim 13, wherein the logic is to remove one or more data points associated with the data defect.

17. The semiconductor apparatus of claim 13, wherein the data defect is a drift condition and the logic is to modify a portion of the sensor data from a sensor associated with the data defect based on the drift condition.

18. The semiconductor apparatus of claim 13, wherein the logic is to assign labels to the plurality of clusters.

19. The semiconductor apparatus of claim 13, wherein the logic is to track indices of sensors associated with the sensor data.

20. The semiconductor apparatus of claim 13, wherein the logic includes transistor channel regions that are positioned within the one or more substrates.

21. A method comprising:
grouping sensor data into a plurality of clusters based on feature similarity;
conducting an artificial intelligence (AI) analysis of the plurality of clusters; and
detecting a data defect based on the AI analysis.

22. The method of claim 21, further including substituting historical data for data associated with the data defect.

23. The method of claim 21, further including predicting a future defect based on the detected data defect.

24. The method of claim 21, further including removing one or more data points associated with the data defect.

25. The method of claim 21, wherein the data defect is a drift condition and the method further includes modifying a portion of the sensor data from a sensor associated with the data defect based on the drift condition.
